(19) United States
(12) Patent Application Publication
(10) Pub. No.: US 2009/0279171 A1
(43) Pub. Date: Nov. 12, 2009

(54) Method and Apparatus for Providing an Adjustable Optical Delay

(75) Inventor: William Conrad Stenton, Midland (CA)

Correspondence Address: HAYNES AND BOONE, LLP;IP Section, 2323 Victory Avenue, Suite 700, Dallas, TX, 75219, US

(73) Assignee: Raytheon Company, Waltham, MA (US)

(21) Appl. No.: 12/118,913

(22) Filed: May 12, 2008

(51) Int. Cl. G02B 5/122

(52) U.S. Cl. 359/529

(57) ABSTRACT

An optical structure routes radiation from an optical input to an optical output, the radiation being successively reflected by orthogonal first, second and third reflective surfaces of a linearly movable section, and departing the section in a departure direction substantially opposite its arrival direction. The section can move approximately parallel to the arrival direction with respect to at least one of the optical input and optical output. A different aspect involves: routing radiation from an optical input to an optical output, including reflecting this radiation successively from orthogonal first, second and third reflective surfaces of a section of the structure, the radiation departing the section in a departure direction substantially opposite its arrival direction; and supporting the section for approximately linear movement approximately parallel to the arrival direction with respect to at least one of the optical input and optical output.

### FIELD OF THE INVENTION

This invention relates in general to optical systems and, more particularly, to techniques for providing an adjustable optical delay.

### BACKGROUND

In optical systems, it is sometimes desirable to have an optical delay that can be adjusted. One known approach is to fixedly mount two planar mirrors on a movable support, so that the mirrors form an angle of 90° with respect to each other. Radiation exiting an end of a first optical fiber is passed through a collimating lens, is then successively reflected by the two mirrors, is then passed through an imaging lens, and then enters an end of a second optical fiber. The support for the mirrors can be moved toward and away from the ends of the optical fibers, in order to increase or decrease the length of the optical path, thereby increasing or decreasing the amount of optical delay. In this pre-existing system, the mirrors must be extremely precisely aligned with respect to each other, with respect to the lenses, and with respect to the ends of the optical fibers. Further, the support for the mirrors must move in a manner that is extremely precise, in order to accurately maintain all of these alignments.

Although systems of this type have been generally adequate for their intended purposes, they have not been satisfactory in all respects. For example, they are extremely sensitive to mirror alignment, and to any tilt or tip of the support for the mirrors. Consequently, in order to achieve the necessary precision, these systems tend to be relatively expensive. Moreover, over time, normal operational wear and tear can lead to play in the movement of the support, and/or misalignment of the mirrors, thereby necessitating either recalibration, and/or replacement of part or all of the structure that supports and moves the mirrors.

### BRIEF DESCRIPTION OF THE DRAWINGS

A better understanding of the present invention will be realized from the detailed description that follows, taken in conjunction with the accompanying drawing, in which:

FIG. 1 is diagrammatic perspective view of an optical apparatus that provides an adjustable optical delay, and that embodies aspects of the invention.

FIG. 2 is a diagrammatic perspective view of an apparatus that is an alternative embodiment of the apparatus of FIG. 1, and that embodies aspects of the invention.

### DETAILED DESCRIPTION

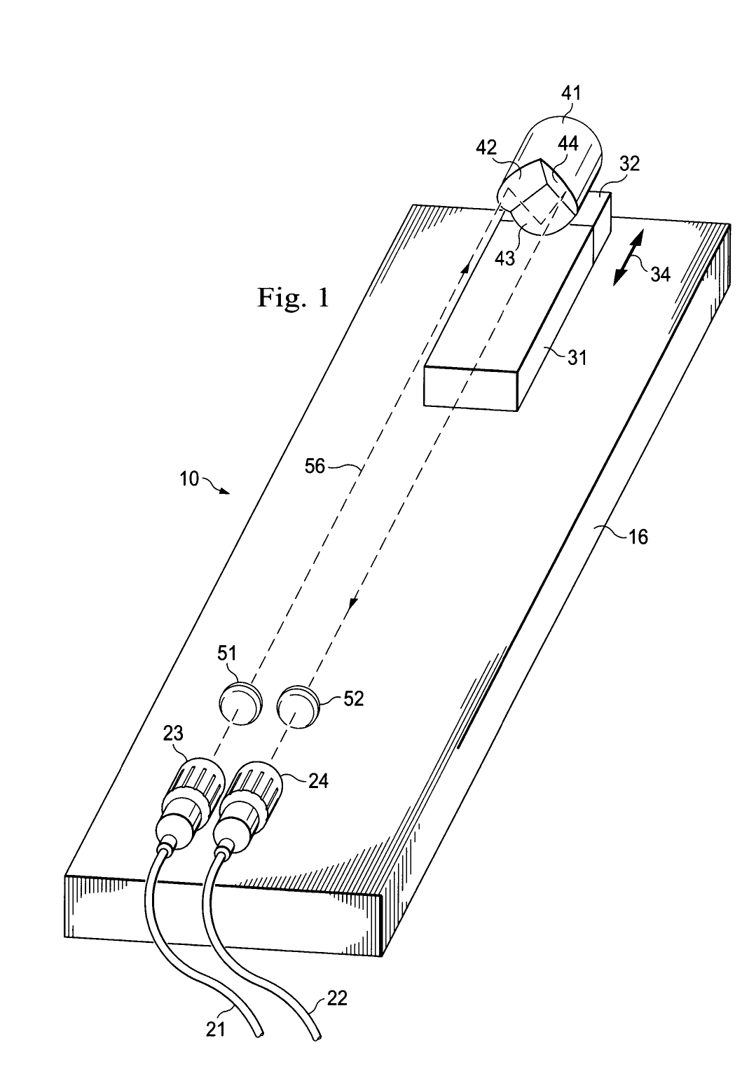

FIG. 1 is diagrammatic perspective view of an optical apparatus 10 that provides an adjustable optical delay, and that embodies aspects of the invention. The apparatus 10 includes a base 16. An optical input fiber 21 has a terminator 23 at one end, and an optical output fiber 22 has a terminator 24 at one end. The terminators 23 and 24 are spaced a short distance from each other, and are each fixedly secured to one end of the base 16 by not-illustrated brackets.

A linear motor 31 of a known type is fixedly secured to the base 16, near an end of the base remote from the terminators 23 and 24. A support 32 is provided adjacent the linear motor 31. The linear motor 31 can selectively effect linear movement of the support 32 in directions identified by a double-headed arrow 34.

A member 41 is fixedly secured on the support 32, for movement with the support in the directions 34. The member 41 has a recess in a side thereof facing the terminators 23 and 24, the recess being defined by three reflective planar surfaces 42, 43 and 44. Each of the surfaces 42, 43 and 44 is perpendicular to the other two. Thus, the three surfaces 42-44 collectively define a shape that is equivalent to one corner of a cube.

A collimating lens 51 is fixedly supported on the base 16 by a not-illustrated bracket, at a location that is near the terminator 23, and that is optically between the terminator 23 and the member 41. Similarly, an imaging lens 52 is fixedly supported on the base 16 by a not-illustrated bracket, at a location that is near the terminator 24, and that is optically between the terminator 24 and the member 41.

When radiation exits the input fiber 21 through the terminator 23, it follows a path of travel 56. This path of travel extends from the terminator 23 through the lens 51 to the member 41, approximately parallel to the directions 34. The lens 51 collimates radiation passing through it. When the radiation reaches the member 41, it is successively reflected by the three surfaces 42, 43 and 44. One of the inherent properties of this configuration of three orthogonal surfaces is that, after successive reflection by all three surfaces, the radiation will depart the member 41 in a direction that is parallel to and precisely opposite the direction in which it arrived. This will be the case even if the member 41 is misaligned with respect to the arriving radiation, provided the radiation is successively reflected by all three of the surfaces. Thus, the directions of linear movement 34 of the member 41 do not have to be precisely parallel to the directions in which radiation arrives at and departs from the member 41.

The radiation departing the member 41 continues along the path of travel 56, and passes through the imaging lens 52. The lens 52 takes this collimated radiation, and images it toward the terminator 24. The radiation then enters the end of output fiber 22 through the terminator 24.

The linear motor 31 can be selectively activated in order to move the support 32 and the member 41 either away from or toward the terminators 23 and 24, parallel to the directions 34. As the member 41 is moved away from the terminators 23 and 24, the length of the optical path of travel 56 is increased, with a corresponding increase in the optical delay imparted to radiation traveling along the path of travel. Conversely, when the support 32 and the member 41 are moved toward the terminators 23 and 24, the length of the optical path of travel 56 is decreased, with a corresponding decrease in the optical delay imparted to radiation traveling along the path of travel. The amount of adjustability needed for the delay will determine the length of linear movement needed for the support 32 and the member 41. It should be noted that the length of the optical path of travel increases or decreases by an amount that is twice the distance moved by the member 41. As a result of this “folding” of the optical path of travel, the overall apparatus 10 is physically smaller than it otherwise would be. Also, by reducing the amount of movement needed from the member 41 in order to achieve a given change in the optical delay, the apparatus can be adjusted more quickly to effect that change in the delay.

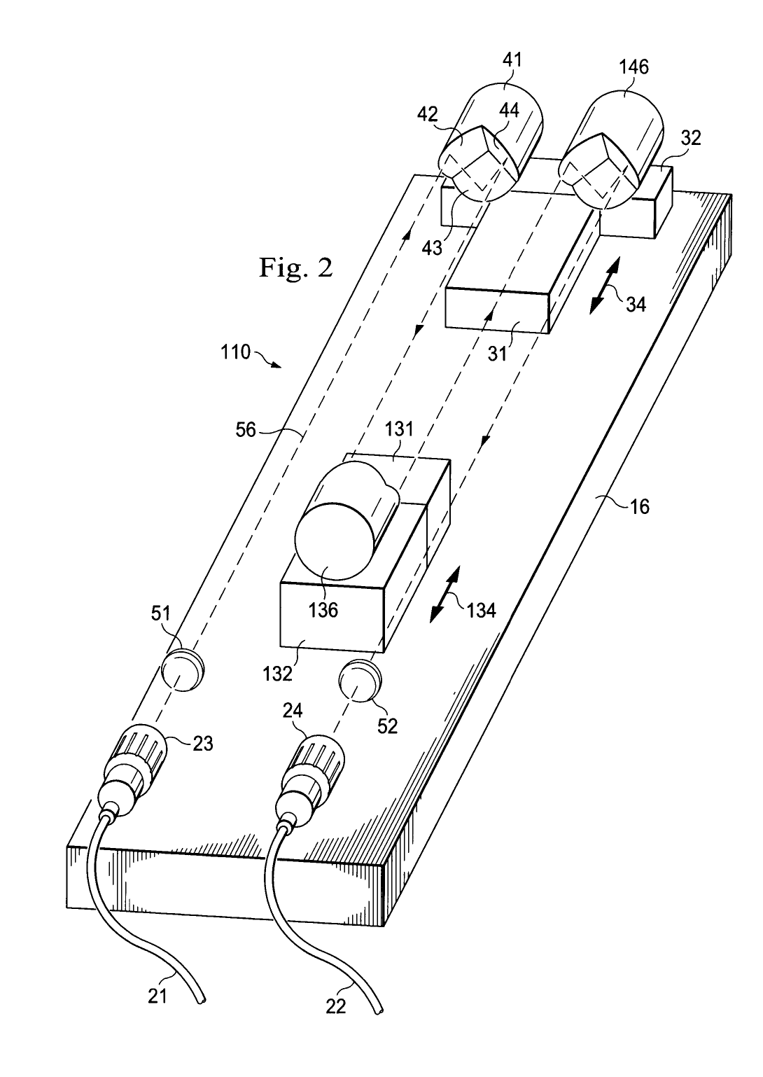

FIG. 2 is a diagrammatic perspective view of an apparatus 110 that is an alternative embodiment of the apparatus 10 of FIG. 1. Parts in FIG. 2 that are identical to parts in FIG. 1 are identified with the same reference numerals. The following discussion is directed primarily to differences between the two embodiments.

In addition to the linear motor 31 and the support 32, the apparatus 110 of FIG. 2 also includes a further linear motor 131 and a further support 132. The support 132 is positioned closer to the terminators 23 and 24 than the support 32. The linear motor 131 can effect reciprocal linear movement of the support 132, in directions 134 that are approximately parallel to the directions of movement 34 of the support 32.

The apparatus 110 of FIG. 2 includes two members 136 and 146 that are each identical to the member 41. The member 136 is fixedly mounted on the support 132, and is oriented so that its recess faces away from the terminators 23 and 24. The member 146 is fixedly mounted on the support 32, at a location spaced a short distance laterally from the member 41, with its recess facing toward the terminators 23 and 24.

In operation, radiation exiting the input fiber 22 through terminator 23 passes through the collimating lens 51, travels to and is successively reflected by the three surfaces in the recess of the member 41, then travels to and is successively reflected by the three surfaces in the recess of member 136, then travels to and is successively reflected by the three surfaces in the recess of member 146, then passes through the imaging lens 52, and then enters the end of output fiber 22 through the terminator 24. In order to increase the optical delay imparted to radiation traveling along the path of travel 56 in apparatus 110, the linear motor 31 can be selectively used to move the members 41 and 146 away from the terminators 23 and 24, and/or the linear motor 131 can be selectively used to move the member 136 toward the terminators 23 and 24. Conversely, in order to decrease the optical delay imparted to radiation by the apparatus 110, the linear motor 31 can be selectively used to move the members 41 and 146 toward the terminators 23 and 24, and/or the linear motor 131 can be selectively used to move the member 136 away from the terminators 23 and 24. As a result of this “folding” of the optical path of travel, the overall apparatus 110 is physically smaller than it otherwise would be. Also, by reducing the amount of movement needed from the members 41, 136 and 146 in order to achieve a desired change in the optical delay, and by providing multiple members 41, 136 and 141 that can be moved simultaneously, the apparatus can be adjusted more quickly to effect a desired change in the delay. Although FIG. 1 shows one member 41, and FIG. 3 shows three members 41, 136 and 146, it would alternatively be possible to provide two such members, or to provide four or more such members.

As discussed above, the members 41, 136 and 146 each output radiation in a direction exactly opposite and parallel to the direction in which that radiation arrived, so long as the radiation reflects successively off all three of the surfaces in the recess of the member. Consequently, the directions of movement 34 and 134 of the supports 32 and 132 do not have to be precisely aligned with respect to each other, or with respect to the directions of travel of radiation arriving at these members. Moreover, in regard to the mounting of the members 41, 136 and 146 on the supports 32 and 132, none of the members 41, 132 and 146 needs to be precisely aligned with respect to either of the directions of travel 34 and 134, or with respect to the directions of travel of radiation arriving at these members. It is only necessary that there be sufficient alignment so that radiation traveling along the path of travel 56 will be successively reflected by all three surfaces on each of the members 41, 136 and 146, in all operational positions of these members. Consequently, the apparatus 10 of FIG. 1 and the apparatus 110 of FIG. 2 do not require highly precise tolerances of the type that are essential in pre-existing systems. As a result, the apparatus 10 and the apparatus 110 are each cheaper than pre-existing systems, and less likely to go out of alignment over time due to factors such as temperature, or normal wear and tear.

In the disclosed embodiments, the recesses in the members 41, 136 and 146 are each an “open” cube corner, in that there is no structure within the recess, and radiation is successively reflected by all three surfaces without passing through any other structure. This configuration has the benefit of avoiding changes to the phase/polarization of the radiation. Alternatively, however, it would be possible to replace any or all of the members 41, 136 and 146 with a prism having three exterior surfaces that are each coated so as to make the surface reflective within the prism. Radiation would enter the prism, be successively reflected within the prism by each of the three surfaces, and then exit the prism. The use of such prisms may be acceptable for applications where changes in phase/polarization are not of significant concern.

Although selected embodiments have been illustrated and described in detail, it should be understood that a variety of substitutions and alterations are possible without departing from the spirit and scope of the present invention, as defined by the claims that follow.

What is claimed is:

1. An apparatus comprising:
an optical input;
an optical output;
optical structure that routes radiation along a path of travel from said optical input to said optical output, said optical structure including a section having reflective first, second and third surfaces that are each substantially planar and that are each substantially normal to the other two thereof, radiation propagating along said path of travel arriving at said section in a first direction, being successively reflected by said first, second and third surfaces, and departing said section in a second direction substantially opposite said first direction; and
support structure supporting said section for movement with respect to one of said optical input and said optical output, said movement of said section being approximately linear movement that takes place approximately parallel to said first direction.

2. An apparatus according to claim 1, wherein said approximately linear movement of said section is movement with respect to both of said input section and said output section.

3. An apparatus according to claim 1, wherein said optical structure includes first and second lenses, radiation from said optical input passing through said first lens, thereafter being reflected by said first, second and third surfaces, thereafter passing through said second lens, and thereafter reaching said optical output.

4. An apparatus according to claim 1, wherein said first, second and third surfaces form an open cube corner.

5. An apparatus according to claim 1, wherein said optical structure includes first and second sections, said first section being said section having said first, second and third surfaces, and said second section having reflective fourth, fifth and sixth surfaces that are each substantially planar and that are each substantially normal to the other two thereof, radiation propagating along said path of travel arriving at said second section in a third direction, being successively reflected by said fourth, fifth and sixth surfaces, and then departing said second section in a fourth direction substantially opposite said third direction.

6. An apparatus according to claim 5, wherein said third direction is substantially the same as said second direction.

7. An apparatus according to claim 5,
wherein said first, second and third surfaces form an open cube corner; and
wherein said fourth, fifth and sixth surfaces form an open cube corner.

8. An apparatus according to claim 5, wherein said support structure supports said second section for movement with respect to said first section and said one of said optical input and said optical output, said movement of said second section being approximately linear movement that takes place approximately parallel to said third direction.

9. An apparatus according to claim 5, wherein said optical structure includes a third section having reflective seventh, eighth and ninth surfaces that are each substantially planar and that are each substantially normal to the other two thereof, radiation propagating along said path of travel arriving at said third section in a fifth direction, being successively reflected by said seventh, eighth and ninth surfaces, and departing said third section in a sixth direction approximately opposite said fifth direction.

10. An apparatus according to claim 9, wherein said third direction is substantially the same as said second direction, and said fifth direction is substantially the same as said first direction.

11. An apparatus according to claim 9,
wherein said first, second and third surfaces form an open cube corner;
wherein said fourth, fifth and sixth surfaces form an open cube corner; and
wherein said seventh, eighth and ninth surfaces form an open cube corner.

12. An apparatus according to claim 9, wherein said support structure supports said third section for movement with respect to said second section and said one of said optical input and said optical output, said movement of said third section being approximately linear movement that takes place approximately parallel to said fifth direction.

13. An apparatus according to claim 12,
wherein said fifth direction is substantially the same as said first direction; and
wherein said third section is fixedly coupled to said first section, said approximately linear movement of said third section occurring simultaneously with and in the same direction as said approximately linear movement of said first section.

14. An apparatus according to claim 13,
wherein said third direction is substantially the same as said second direction; and
wherein said support structure supports said second section for movement with respect to said first and third sections and said one of said optical input and said optical output, said movement of said second section being approximately linear movement that takes place approximately parallel to said first direction, and said approximately linear movement of each of said first, second and third sections being movement with respect to both of said input section and said output section.

15. A method comprising:
routing radiation along a path of travel from an optical input to an optical output using optical structure having a section with reflective first, second and third surfaces that are each substantially planar and that are each substantially normal to the other two thereof, wherein radiation propagating along said path of travel arrives at said section in a first direction, is successively reflected by said first, second and third surfaces, and departs said section in a second direction substantially opposite said first direction; and
supporting said section for movement with respect to one of said optical input and said optical output, said movement of said section being approximately linear movement that takes place approximately parallel to said first direction.

16. A method according to claim 15,
including configuring said optical structure to have first and second sections, said first section being said section with said first, second and third surfaces, and said second section having reflective fourth, fifth and sixth surfaces that are each substantially planar and that are each substantially normal to the other two thereof; and
wherein said routing includes causing radiation propagating along said path of travel to arrive at said second section in a third direction, to be successively reflected by said fourth, fifth and sixth surfaces, and to then depart said second section in a fourth direction substantially opposite said third direction.

17. A method according to claim 16, including orienting said third direction so that it is substantially the same as said second direction.

18. A method according to claim 16, including supporting said second section for movement with respect to said first section and said one of said optical input and said optical output, said movement of said second section being approximately linear movement that takes place approximately parallel to said third direction.

19. A method according to claim 16,
wherein said optical structure includes a third section having reflective seventh, eighth and ninth surfaces that are each substantially planar and that are each substantially normal to the other two thereof; and
wherein said routing includes causing radiation propagating along said path of travel to arrive at said third section in a fifth direction, to be successively reflected by said seventh, eighth and ninth surfaces, and to depart said third section in a sixth direction substantially opposite said fifth direction.

20. A method according to claim 19, including:
orienting said third direction so that it is substantially the same as said second direction; and
orienting said fifth direction so that it is substantially the same as said first direction.

21. A method according to claim 19, including supporting said third section for movement with respect to said second section and said one of said optical input and said optical output, said movement of said third section being approximately linear movement that takes place approximately parallel to said fifth direction.

22. A method according to claim 21, including:
orienting said fifth direction so that it is substantially the same as said first direction;
physically coupling said third section to said first section; and
carrying out said approximately linear movement of said third section simultaneously with and in approximately the same direction as said approximately linear movement of said first section.

23. A method according to claim 22, including:
orienting said third direction so that it substantially the same as said second direction; and
supporting said second section for movement with respect to said first and third sections and said one of said optical input and said optical output, said movement of said second section being approximately linear movement that takes place approximately parallel to said first direction, and said approximately linear movement of each of said first, second and third sections being movement with respect to both said optical input and said optical output.
